(19) United States
(12) Patent Application Publication
(10) Pub. No.: US 2020/0170280 A1
(43) Pub. Date: Jun. 4, 2020

(54) METAL COMPLEX OR METAL CHELATE COMPOSITIONS COMPRISING MINIMAL NANOPARTICLES

(71) Applicant: Balchem Corporation, New Hampton, NY (US)

(72) Inventors: Ren Gonzalez, New Hampton, NY (US); Tod Jenness, New Hampton, NY (US)

(21) Appl. No.: 16/694,590

(22) Filed: Nov. 25, 2019

Related U.S. Application Data
(60) Provisional application No. 62/773,617, filed on Nov. 30, 2018.

(51) Int. Cl. A23K 20/10; C07F 3/06; C07F 3/02; C07F 3/04; C07F 15/02

(52) U.S. Cl. CPC A23K 20/10; C07F 3/06; C07F 15/02; C07F 3/04; C07F 3/02

(57) ABSTRACT

The present disclosure generally relates to metal complex or metal chelate compositions comprising minimal nanoparticles wherein the compositions maintain flowability.

### CROSS REFERENCE TO RELATED APPLICATIONS

This application claims priority to U.S. Provisional Application No. 62/773,617, filed Nov. 30, 2018, the disclosures of which are incorporated herein by reference.

### FIELD OF THE INVENTION

The present disclosure generally relates to metal complex or metal chelate compositions comprising minimal nanoparticles wherein the compositions maintain flowability.

### BACKGROUND OF THE INVENTION

Metal complex or metal chelates are prevalent in many areas of society. They are widely used in the agricultural field to deliver agrochemically valuable nutrients to a variety of plants. In the imaging field, metal complexes or metal chelates (especially gadolinium chelates) are utilized in MRI (magnetic resonance imaging) as an imaging agent. Metal complexes or metal chelates are also used in the food industry as nutritional supplements, consumed by athletes as performance enhancements, used as antimicrobial agents, and used as antioxidants. Other industries which use metal complexes or metal chelates are the pharmaceutical industry, photographic industry in photographic processing, and in the manufacture of catalysts.

In the current practice of manufacturing metal complexes or metal chelates, inclusion of a desiccant is considered mandatory to prevent and/or reduce oxidation of the metal ion by reducing the amount of internal moisture activity that drives the oxidative process. Furthermore, the addition of a desiccant to a chelated metal composition reduces caking and increases flowability of the reacted material in manufacturing and blending equipment. As a result, addition of a desiccant increases throughput and yield, while reducing wear and tear on equipment and down time due to cleaning equipment between manufacturing runs.

A key concern regarding use of a desiccant is the particle size, as desiccants may contain nanoparticles. Because nanoparticles are small enough to penetrate the skin, lungs, digestive system, and perhaps pass through the blood-brain barrier, there is increasing concern that use of additives, such as desiccants, in food, pharmaceuticals, and other consumer products are exposing consumers to potentially hazardous nanoparticles. The desiccant silicon dioxide, for example, is comprised of aggregated nanosized primary particles. The sizes of the aggregates and agglomerates are normally greater than 100 nm. However, depending on the starting material and/or on the manufacturing process, some aggregates of the primary particles may disintegrate to particles smaller than 100 nm in size—which is classified as a nanoparticle by definition.

Therefore, there is a need for metal complex or metal chelate compositions that contain minimal amounts of nanoparticles while demonstrating low moisture levels and/or activity while maintaining flowability.

### BRIEF DESCRIPTION OF THE FIGURES

FIG. 1 is an image of ferrous bisglycinate formulated with fumed silica. The image shows the presence of nanoparticles. The image is representative of transmission electron microscopy (TEM) performed on the ferrous bisglycinate containing fumed silica wherein the scale as indicated is 200 nm.

### DETAILED DESCRIPTION OF THE INVENTION

Current commercial metal complex or metal chelate compositions require use of a desiccant to reduce water content and water activity of the composition and increase flowability of the composition. Certain desiccants, however, result in nanoparticulate contamination of the metal complex or metal chelate composition. Importantly, the present disclosure provides metal complex or metal chelate compositions with minimal nanoparticle amounts, as detailed below. In general, the metal complex or metal chelate compositions disclosed herein comprise one or more metal ions and one or more ligands. In various embodiments, metal complex or metal chelate compositions of the present disclosure have minimal nanoparticles, low water content and low water activity. In various embodiments, metal complex or metal chelate compositions of the present disclosure maintain flowability.

### (I) Metal Complex or Metal Chelate Compositions

One aspect of the present disclosure encompasses a metal complex or metal chelate composition comprising one or more metal complex or metal chelates. These metal complexes or metal chelates comprise a metal ion or metal ions bound to one or more ligands. The metal complex or metal chelate compositions further comprise minimal nanoparticles in the absence of a desiccant. The metal complex or metal chelate compositions further comprise low moisture levels, low moisture activities, and maintain flowability. In preferred embodiments, the metal complex or metal chelate composition is an organic metal complex or organic metal chelate composition, meaning that the ligand is an organic molecule.

(a) Metal Complex or Metal Chelate Compounds

In various embodiments, the metal complex or metal chelate compositions disclosed herein comprise at least one or more metal complexes or metal chelates. As used herein, “metal chelates” and “metal chelate compounds” are used interchangeably. Similarly, “metal complexes” and “metal complex compounds” are used interchangeably. Generally speaking, metal complex compounds are obtained by coordination bonding of at least one metal ion with at least one ligand. Metal chelate compounds are obtained by coordination boding of at least one metal ion with at least one multidentate ligand.

A ligand, as used herein, may be an amino acid or derivative thereof, an organic acid or derivative thereof, a monosaccharide or derivative thereof, a protein or derivative thereof (e.g., hydrolysate), or other monodentate or multidentate ligand (such as ethylene diamine). In embodiments in which the metal complex or metal chelate comprises an amino acid, the amino acid may be alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine or their hydroxy analogs. In some embodiments, the amino acid may be a non-proteogenic amino acid. Non-limiting examples of non-proteogenic amino acids may include GABA and beta-alanine, among others. In certain embodiments, a ligand may be an amino sulfonic acid (e.g. taurine). Suitable organic acids may include without limit ascorbic acid, citric acid, fumaric acid, gallic acid, gluconic acid, lactic acid, malic acid, succinic acid, and the like. In certain embodiments, the organic chelate is a glycinate, bisglycinate, asparto glycinate, lysinate, malate, aspartate, lysyl glycinate, glycyl glutamine, or citrate chelate.

Various metal ions may be used in this capacity. Non-limiting examples of metal ions include actinide metal ions, alkaline earth metal ions, transition metal ions, lanthanide metal ions, and p-block metal ions. In various embodiments, the metal ion may be an alkali earth metal ion chosen from magnesium ions, calcium ions, beryllium ions, barium ions, strontium ions, or radium ions where the ions are divalent in nature. In other embodiments, the metal ion may be a transition metal ion. In various embodiments, the transition metal ion may be chosen from scandium ions, yttrium ions, titanium ions, zirconium ions, hafnium ions, vanadium ions, niobium ions, tantalum ions, chromium ions, molybdenum ions, tungsten ions, manganese ions, technetium ions, rhenium ions, iron ions, ruthenium ions, osmium ions, cobalt ions, rhodium ions, iridium ions, nickel ions, palladium ions, platinum ions, copper ions, silver ions, or gold ions. Generally, these transition metal ions may be in various oxidation states from 1⁺ to 8⁺. In some embodiments, the metal ion may be a lanthanide ion. In various embodiments, the lanthanide ion may be chosen from lanthanide ions, cerium ions, praseodymium ions, neodymium ions, promethium ions, samarium ions, europium ions, gadolinium ions, terbium ions, dysprosium ions, holmium ions, erbium ions, thulium ions, ytterbium ions, or lutetium ions. In various embodiments, the lanthanide ion may be in various oxidation states from 2⁺ to 4⁺. In some embodiments, the metal ion may be an actinium ion. In various embodiments, the actinium ions ion may be in various oxidation states from 2⁺ to 6⁺. In certain embodiments, the metal ion may be a d-block metal ion, such as cadmium ions or zinc ions. In various embodiments, the d-block metal ions may be in various oxidation states, including 2+. In another embodiment, the metal ion may be a p-block metal ion chosen from aluminum ions, antimony ions, arsenic ions, bismuth ions, gallium ions, germanium ions, indium ions, lead ions, mercury ions, polonium ions, selenium ions, tellurium ions, thallium ions, or tin ions. In various embodiments, the p-block metal ions ion may be in various oxidation states from 1⁺ to 6⁺. In other embodiments, the metal ion may be an aluminum ion, calcium ion, chromium ion, cobalt ion, copper ion, gallium ion, germanium ion, gold ion, indium ion, iron ion, magnesium ion, manganese ion, molybdenum ion, nickel ion, selenium ion, silver ion, strontium ion, tin ion, titanium ion, vanadium ion, zinc ion, zirconium ion, or combination thereof. In some embodiments, the metal ion may be zinc, copper, magnesium, manganese, iron, chromium, selenium, calcium, or combinations thereof.

The ratio of the ligand to the metal ion will vary depending on the nature of the ligand(s) and the metal ion(s). The ratio of ligand to metal ion may generally vary from 1:4 to 4:1 or higher. In various embodiments, the mole ratio of the metal ion to the ligand may be 1:1 to about 4:1. In other embodiments, the mole ratio of the metal ion to the ligand may be 1:1 to 4:1, from 1:1 to 2:1, or from 2:1 to 3:1, or from 3:1 to 4:1. In other embodiments, the mole ratio of the metal ion to the ligand may be 1:1 to 1:2. In other embodiments, the mole ratio of the metal ion(s) to the ligand may be 2:1 to 4:1. In other embodiments, a metal complex or metal chelate may comprise a mixture of 1:1, 2:1 and 3:1 species. In yet other embodiments, the ratio of ligand to metal ion in the metal complex or metal chelate compound may generally vary from 1.5:1 to 2.5:1. In certain embodiments, the ratio of ligand to metal ion in the metal xompex or metal chelate compound may generally vary from 3:2 to 2:3. In some embodiments, a metal complex or metal chelate may comprise the same metal ion(s). In other embodiments, a metal complex or metal chelate may comprise two or more different metal ions coordinated to the ligand(s).

In embodiments in which the ligand is an amino acid and when the number of ligands equates to the charge on the metal ion, the charge may be, but is not required to be, balanced because the carboxyl moieties of the amino acids are in deprotonated form. For example, in the chelate species wherein the metal cation carries a charge of 2+ and the amino acid to metal ratio is 2:1, each of the hydroxyl or amino groups may be bound by a coordinate covalent bond to the metal while an ionic bond prevails between each of the carboxylate groups and the metal ion. Where the number of ligands exceeds the charge on the metal ion, e.g., in a 3:1 chelate of a divalent metal ion, the amino acids in excess of the charge may remain in a protonated state to balance the charge. On the other hand, where the positive charge on the metal ion exceeds the number of amino acids, the charge may be balanced by the presence of another anion such as, for example, chloride, bromide, iodide, bicarbonate, hydrogen sulfate, dihydrogen phosphate and combinations thereof. Divalent anions may also be present.

In preferred embodiments, a metal complex or metal chelate of the invention may be ferrous bisglycinate, ferrous asparto glycinate, ferric glycinate, calcium bisglycinate, calcium citrate malate, calcium citrate, zinc bisglycinate, zinc arginate, dicalcium malate, magnesium bisglycinate, magnesium lysinate glycinate, magnesium aspartate, magnesium glycyl glutamine, dimagnesium malate, magnesium citrate, iron citrates, iron malates, iron succinates, or combinations thereof.

(b) Nanoparticles

In various embodiments, the metal complex or metal chelate compositions disclosed herein comprise minimal nanoparticles. As used herein, a “nanoparticle” or “nanoparticles” refers to chemical substances or materials with particle sizes between 1 and 100 nanometers (nm) in at least one dimension. A nanoparticle as disclosed herein may occur naturally (natural nanoparticle), be produced unintentionally (incidental nanoparticle), or be intentionally engineered (engineered nanoparticle). Generally, the nanoparticles of the metal complex or metal chelate composition may be process by-products and/or additives. In various embodiments, nanoparticles are formed by aggregation and/or agglomeration of an additive, such as a desiccant. In various embodiments, a metal complex or metal chelate composition may contain less than about 15%, less than about 10%, less than about 5%, or less than about 1% total amount of one or more desiccants by total weight of the composition. In other embodiments, a metal complex or metal chelate composition may not contain a desiccant. Non-limiting examples of desiccants may include silica, bauxite, montmorillonite clay, calcium oxide, calcium sulfate, zeolites, and derivatives thereof.

In various embodiments, a minimal nanoparticle metal complex or metal chelate composition may comprise less than about 3% nanoparticles, less than about 2% nanoparticles, or less than about 1% nanoparticles by total weight of the composition. In yet other embodiments, metal complex or metal chelate compositions may comprise less than about 0.9, 0.8, 0.7, 0.6, or 0.5% nanoparticles. In preferred embodiments, a minimal nanoparticle metal complex or metal chelate composition comprises less than about 0.5%, 0.4%, 0.3%, 0.2%, or 0.1% nanoparticles by total weight of the composition. In further preferred embodiments, a minimal nanoparticle metal complex or metal chelate composition may not comprise detectable nanoparticles, as measured by transmission electron microscopy of random samples taken from the composition.

In various embodiments, a metal complex or metal chelate composition comprising iron may comprise less than about 0.5%, 0.4%, 0.3%, 0.2%, or 0.1% nanoparticles by total weight of the composition. In further embodiments, a minimal nanoparticle iron complex or iron chelate composition may not comprise detectable nanoparticles, as measured by transmission electron microscopy of random samples taken from the composition. A minimal nanoparticle iron complex or iron chelate composition will typically not contain a desiccant. Preferred iron complexes or iron chelates may include ferrous bisglycinate, ferrous asparto glycinate, or ferric glycinate. Additional iron complexes or iron chelates may also include iron citrates, iron malates, iron succinates, or combinations thereof.

In other embodiments, a metal complex or metal chelate composition comprising magnesium may comprise less than about 0.5%, 0.4%, 0.3%, 0.2%, or 0.1% nanoparticles by total weight of the composition. In further embodiments, a minimal nanoparticle magnesium complex or magnesium chelate composition may not comprise detectable nanoparticles, as measured by transmission electron microscopy of random samples taken from the composition. A minimal nanoparticle magnesium complex or magnesium chelate composition will typically not contain a desiccant. Preferred magnesium complexes or magnesium chelates may include magnesium bisglycinate, magnesium lysinate glycinate, magnesium aspartate, magnesium glycyl glutamine, dimagnesium malate, or magnesium citrate.

In yet other embodiments, a metal complex or metal chelate composition comprising zinc may comprise less than about 0.5%, 0.4%, 0.3%, 0.2%, or 0.1% nanoparticles by total weight of the composition. In further embodiments, a minimal nanoparticle zinc complex or zinc chelate composition may not comprise detectable nanoparticles, as measured by transmission electron microscopy of random samples taken from the composition. A minimal nanoparticle zinc complex or zinc chelate composition will typically not contain a desiccant. Preferred zinc complexes or zinc chelates may include zinc bisglycinate or zinc arginate.

In other embodiments, a metal complex or metal chelate composition comprising calcium may comprise less than about 0.5%, 0.4%, 0.3%, 0.2%, or 0.1% nanoparticles by total weight of the composition. In further embodiments, a minimal nanoparticle calcium complex or calcium chelate composition may not comprise detectable nanoparticles, as measured by transmission electron microscopy of random samples taken from the composition. A minimal nanoparticle calcium complex or calcium chelate composition will typically not contain a desiccant. Preferred calcium complexes or calcium chelates may include calcium bisglycinate, calcium citrate malate, calcium citrate, and dicalcium malate.

The % nanoparticles by weight may be determined by centrifugal sedimentation of a suspension of the material in water. By this method, larger particles are separated from the nanoparticles, which remain suspended on the aqueous layer and are measured by evaporation of the water. In addition, the % nanoparticles by weight may be determined by a gravimetric quantitation of the nanoparticles. For instance, an initial sample aliquot may be correlated to the minimum weight parameter of a given balance (USP) so that it could be used as a quantitative limit test, i.e. show that a sample is not above a specified weight percentage, even if the specific weight of the “absence” of nanoparticles is not specified.

In other embodiments, nanoparticles may be analyzed utilizing optical analyses. In these embodiments, the percentage of nanoparticles would be a ratio of the number of particles analyzed as opposed to a weight percentage.

(c) Water Content

In various embodiments, the metal complex or metal chelate compositions disclosed herein comprise low water content. As used herein, “water content”, “water levels”, “moisture content” and “moisture levels” are used interchangeably. As used herein, “water content” is defined as the quantity of total water contained in a composition. In general, total water encompasses water bound to components of a composition and free or unbound water within a composition. Water content in a composition may be expressed as a percentage of the total weight. Water content may be measured using methods commonly known in the art. In preferred embodiments, water content is measured by thermogravimetric analysis.

In various embodiments, water content of a metal complex or metal chelate composition of the present disclosure may be less than about 15%, less than about 14%, less than about 13%, less than about 12%, less than about 11%, less than about 10%, less than about 9%, less than about 8%, less than about 7%, less than about 6%, less than about 5%, less than about 4%, less than about 3%, less than about 2%, or less than about 1%.

In various embodiments, water content of a metal complex or metal chelate composition comprising iron may be less than about 7%. For instance, in some embodiments, the water content of a metal complex or metal chelate composition comprising iron may be less than about 7%, less than about 6%, less than about 5%, less than about 4% or less than about 3%. For example, the water content of a metal complex or metal chelate composition comprising ferrous bisglycinate, ferrous asparto glycinate, ferric glycinate, iron citrates, iron malates, iron succinates, or combinations thereof may be less than about 7%, less than about 6%, less than about 5%, less than about 4% or less than about 3%.

In other embodiments, water content of a metal complex or metal chelate composition comprising magnesium may be less than about 12%. For instance, in some embodiments, the water content of a metal complex or metal chelate composition comprising magnesium may be less than about 12%, less than about 11%, less than about 10%, less than about 9%, less than about 8%, less than about 7%, less than about 6%, less than about 5%, less than about 4%, less than about 3%, or less than about 2% For example, the water content of a metal complex or metal chelate composition comprising magnesium bisglycinate, magnesium lysinate glycinate, magnesium aspartate, magnesium glycyl glutamine, dimagnesium malate, or magnesium citrate may be less than about 12%, less than about 11%, less than about 10%, less than about 9%, less than about 8%, less than about 7%, less than about 6%, less than about 5%, less than about 4%, less than about 3%, or less than about 2%.

In still other embodiments, water content of a metal complex or metal chelate composition comprising zinc may be less than about 7%. For example, the water content of a metal complex or metal chelate composition comprising zinc bisglycinate or zinc arginate is less than about 7%, less than about 6%, less than about 5%, less than about 4% or less than about 3%.

In other embodiments, water content of a metal complex or metal chelate composition comprising calcium may be less than about 6%. For instance, the water content of a metal complex or metal chelate composition comprising calcium may be less than about 6%, less than about 5.75%, less than about 5.5%, less than about 5.25%, less than about 5%, less than about 4.75%, less than about 4.5%, less than about 4.25%, less than about 4.0%, less than about 3.75%, less than about 3.5%, less than about 3.25%, or less than about 3%. For example, the water content of a metal complex or metal chelate composition comprising calcium bisglycinate, calcium citrate malate, calcium citrate, or dicalcium malate is less than about 6%, less than about 5.75%, less than about 5.5%, less than about 5.25%, less than about 5%, less than about 4.75%, less than about 4.5%, less than about 4.25%, less than about 4.0%, less than about 3.75%, less than about 3.5%, less than about 3.25%, or less than about 3%.

In each of the above embodiments, the water content in a composition may be measured at the completion of the manufacturing process, e.g. “end of run” measurements. Alternatively, the water content in a composition of the disclosure may be measured after storage in moisture resistant packaging. Suitable examples of moisture resistant packaging/containers may include, but are not limited to, multi-walled paper bags having a suitable moisture barrier, such as aluminum, fiber drums having polymeric or aluminum foil linings integral with the drum wall or loose liners inserts, rigid containers such as blow molded drums and pails made of polymers with moisture barriers, and other suitable moisture resistant packaging/containers. In some embodiments, the container may be a flexible package such as a shipping bag made of a polymer substrate. In one embodiment, the packaging may be made from aluminum foil laminated to polymer films formed from polymers that are commonly used to make moisture resistant packaging (e.g. laminates of aluminum foil with polyolefins, polyesters, styrenics or copolymers thereof).

In various embodiments, the water content may be measured in a metal complex or metal chelate composition after storage in moisture resistant packaging for about 1 day, about 2 days, about 3 days, about 4 days, about 5 days, or about 6 days after manufacture. In other embodiments, the water content may be measured in a metal complex or metal chelate composition after storage in moisture resistant packaging for about 1 week, about 2 weeks, or about 3 weeks after manufacture. In further embodiments, the water content may be measured in a metal complex or metal chelate composition after storage in moisture resistant packaging for about 1 month, about 2 months, about 3 months, about 4 months, about 5 months, about 6 months, about 12 months, or about 24 months. In preferred embodiments, the moisture content of a metal complex or metal chelate composition of the disclosure is less than about 15% when measured at least three months after storage in moisture resistant packaging.

In various embodiments, the low water content of a metal complex or metal chelate composition disclosed herein may limit the microbial growth rate within the composition. For instance, in some embodiments, the water content of a metal complex or metal chelate composition may limit the microbial growth rate within the composition to less than 1000 CFU, using total aerobic plate count. In certain embodiments, the water content may limit the microbial growth rate within the composition to less than 900 CFU, less than 800 CFU, less than 700 CFU, less than 600 CFU, less than 500 CFU, less than 400 CFU, less than 300 CFU, less than 200 CFU, or less than 100 CFU using total aerobic plate count. In some embodiments, water content of a metal complex or metal chelate composition may be at an amount to prevent microbial growth within the composition.

In each of the above low water embodiments, the composition may comprise less than about 0.9, 0.8, 0.7, 0.6, or 0.5% nanoparticles. In preferred embodiments, a low water metal complex or metal chelate composition comprises less than about 0.5%, 0.4%, 0.3%, 0.2%, or 0.1% nanoparticles by total weight of the composition. In further preferred embodiments, a minimal nanoparticle metal complex or metal chelate composition may not comprise detectable nanoparticles, as measured by transmission electron microscopy of random samples taken from the composition.

(d) Water Activity

In various embodiments, the metal complex or metal chelate compositions disclosed herein possess low water activity. As used herein, “water activity” and “moisture activity” are used interchangeably. As used herein, “water activity” represents the ratio of the water vapor pressure of a composition to the water vapor pressure of pure water under the same conditions and is expressed as a fraction. The water activity scale extends from 0 to 1.0 wherein 0 is the absence of unbound water and 1.0 is pure water. Water activity may be measured using means commonly known in the art. In preferred embodiments, water activity is measured using a dew point hygrometer.

In various embodiments, water activity of a metal complex or metal chelate composition of the invention may be less than about 0.6, less than about 0.5, less than about 0.4, less than about 0.3, less than about 0.2, or less than about 0.1.

In various embodiments, water activity of a metal complex or metal chelate composition comprising iron may be less than about 0.6, less than about 0.5, less than about 0.4, less than about 0.3, less than about 0.2, or less than about 0.1. In a preferred embodiment, an iron complex or iron chelate composition of the present disclosure has a moisture level of less than about 7% and a water activity level of less than 0.5. For example, an iron complex or iron chelate composition comprising ferrous bisglycinate, ferrous asparto glycinate, ferric glycinate, iron citrates, iron malates, iron succinates, or combinations thereof may have a water content of less than about 7% and a water activity level of less than 0.5.

In other embodiments, water activity of a metal complex or metal chelate composition comprising magnesium may be less than about 0.6, less than about 0.5, less than about 0.4, less than about 0.3, less than about 0.2, or less than about 0.1. In a preferred embodiment, a magnesium chelate composition of the present disclosure would have a moisture level of less than 12% and a water activity level of less than 0.5. For example, a magnesium chelate composition comprising magnesium bisglycinate, magnesium lysinate glycinate, magnesium aspartate, magnesium glycyl glutamine, dimagnesium malate, or magnesium citrate may have a water content of less than about 12% and a water activity level of less than 0.5.

In still other embodiments, water activity of a metal complex or metal chelate composition comprising zinc may be less than about 0.6, less than about 0.5, less than about 0.4, less than about 0.3, less than about 0.2, or less than about 0.1. In a preferred embodiment, a zinc complex or zinc chelate composition of the present disclosure has a moisture level of less than about 7% and a water activity level of less than 0.5. For example, a zinc complex or zinc chelate composition comprising zinc bisglycinate or zinc arginate may have a water content of less than about 7% and a water activity level of less than 0.5.

In other embodiments, water activity of a metal complex or metal chelate composition comprising calcium may be less than about 0.6, less than about 0.5, less than about 0.4, less than about 0.3, less than about 0.2, or less than about 0.1. In a preferred embodiment, a calcium complex or calcium chelate composition of the present disclosure would have a moisture level of less than 6% and a water activity level of less than 0.5. For example, a calcium complex or calcium chelate composition comprising calcium bisglycinate, calcium citrate malate, calcium citrate, or dicalcium malate may have a water content of less than 6% and a water activity level of less than 0.5.

In each of the above embodiments, the water activity in a composition may be measured at the completion of the manufacturing process, e.g. “end of run” measurements. Alternatively, the water activity in a composition of the disclosure may be measured after storage in moisture resistant packaging. Suitable examples of moisture resistant packaging/containers may include, but are not limited to, multi-walled paper bags having a suitable moisture barrier, such as aluminum, fiber drums having polymeric or aluminum foil linings integral with the drum wall or loose liners inserts, rigid containers such as blow molded drums and pails made of polymers with moisture barriers, and other suitable moisture resistant packaging/containers. In some embodiments, the container may be a flexible package such as a shipping bag made of a polymer substrate. In one embodiment, the packaging may be made from aluminum foil laminated to polymer films formed from polymers that are commonly used to make moisture resistant packaging (e.g. laminates of aluminum foil with polyolefins, polyesters, styrenics or copolymers thereof).

In various embodiments, the water activity may be measured in a metal complex or metal chelate composition after storage in moisture resistant packaging for about 1 day, about 2 days, about 3 days, about 4 days, about 5 days, or about 6 days after manufacture. In other embodiments, the water activity may be measured in a metal complex or metal chelate composition after storage in moisture resistant packaging for about 1 week, about 2 weeks, or about 3 weeks after manufacture. In further embodiments, the water activity may be measured in a metal complex or metal chelate composition after storage in moisture resistant packaging for about 1 month, about 2 months, about 3 months, about 4 months, about 5 months, about 6 months, about 12 months, or about 24 months. In preferred embodiments, the water activity of a metal complex or metal chelate composition of the disclosure is less than about 0.5 when measured at least three months after storage in moisture resistant packaging.

In each of the above embodiments, the composition may comprise less than about 0.9, 0.8, 0.7, 0.6, or 0.5% nanoparticles. In preferred embodiments, a low water activity metal complex or metal chelate composition comprises less than about 0.5%, 0.4%, 0.3%, 0.2%, or 0.1% nanoparticles by total weight of the composition. In further preferred embodiments, a minimal nanoparticle metal complex or metal chelate composition may not comprise detectable nanoparticles, as measured by transmission electron microscopy of random samples taken from the composition.

(e) Flowability

In various embodiments, the metal complex or metal chelate compositions disclosed herein comprise flowability optimized for handling, processing and/or storage needs of the composition. As used herein “flowability” is defined as a property of materials to flow evenly under the action of gravity and other forces. In various embodiments, flowability may be measured using one or more methods as described in detail in the United States Pharmacopeia, Chapter <1174> Powder Flow, the disclosure of which is herein incorporated by reference in its entirety.

In preferred embodiments, flowability may be quantified by determination of the Hausner ratio or the flowability index assessed by a Flodex apparatus. The Hausner ratio is a number that is correlated to the flowability of a powder or granular material. The Hausner ratio is calculated by the formula

$$H = \frac{{ρ}_{T}}{{ρ}_{B}}$$

where ρ_{B} is the freely settled bulk density of the powder, and ρ_{T} is the tapped bulk density of the powder. As used herein, a generally accepted scale of assessing flowability using the Hausner ratio is provided in Table 1.

TABLE 1
Scale of Flowability for the Hausner ratio

| Hausner Ratio | Flow Character |
|---|---|
| 1.00 - 1.11 | Excellent |
| 1.12 - 1.18 | Good |
| 1.19 - 1.25 | Fair |
| 1.26 - 1.34 | Passable |
| 1.35 - 1.45 | Poor |
| 1.46 - 1.59 | Very poor |
| >1.60 | Very, very poor |

In general, determination of flowability using a Flodex apparatus is based upon the ability of the powder to fall freely through a hole in the disc. The Flodex apparatus consists of a receptacle cylinder with interchangeable discs with holes of 4 mm, 5 mm, 6 mm, 7 mm, 8 mm, 9 mm, 10 mm, 12 mm, 14 mm, 16 mm, 18 mm, 20 mm, 22 mm, 24 mm, 26 mm, 28 mm, 30 mm, 32 mm, and 34 mm in diameter. As used herein, the Flowdex index is defined as the millimeter diameter of the smallest hole through which the sample will pass three consecutive tests. The smaller the hole through which the material falls freely, the better the flowability of the material. The Flowdex index as used herein is determined using an arbitrary scale of 4 to 34. As a non-limiting example, a composition with a Flowdex index of 4 would have “excellent” flowability whereas a composition with a Flowdex index of 34 would have “very, very poor” flowability.

In various embodiments, a metal complex or metal chelate composition disclosed herein may have a Hausner ratio of about 1.00 to about 1.25. That is, a metal complex or metal chelate composition of the present disclosure may have a flowability rated as “excellent, good, or fair” as determined by the chart of Table 1 In other embodiments, a metal complex or metal chelate composition disclosed herein may have a Hausner ratio of about 1.19 to about 1.25, of about 1.12 to about 1.18, or of about 1.00 to about 1.11. In some embodiments, a metal complex or metal chelate composition disclosed herein may have a Hausner ratio of less than about 1.25, of less than about 1.24, of less than about 1.23, of less than about 1.22, of less than about 1.22, of less than about 1.21, of less than about 1.20, of less than about 1.19, of less than about 1.18, of less than about 1.17, of less than about 1.16, of less than about 1.15, of less than about 1.14, of less than about 1.13, of less than about 1.12, of less than about 1.11, of less than about 1.10, of less than about 1.09, of less than about 1.08, of less than about 1.07, of less than about 1.06, of less than about 1.05, of less than about 1.04, of less than about 1.03, of less than about 1.02, of less than about 1.01, or of about 1.00.

In various embodiments, a metal complex or metal chelate composition disclosed herein may have excellent flowability as determined by the Flowdex index. In various embodiments, the metal complex or metal chelate compositions disclosed herein may have a Flowdex index of about 4 to about 20. In other embodiments, the metal complex or metal chelate compositions disclosed herein may have Flowdex index of about 16 to about 20, about 10 to about 15,or about 4 to about 9. In other embodiments, the metal complex or metal chelate compositions disclosed herein may have a Flowdex index of less than about 20, of less than about 19, of less than about 18, of less than about 17, of less than about 16, of less than about 15, of less than about 14, of less than about 13, of less than about 12, of less than about 11, of less than about 10, of less than about 9, of less than about 8, of less than about 7, of less than about 6, of less than about 5, or of about 4.

(f) Preferred Compositions

Preferred compositions comprising metal complex or metal chelate compounds of the present disclosure include the compositions listed below in Table 2.

TABLE 2
Preferred Compositions

| | % | % | | | |
|---|---|---|---|---|---|
| | water | water | % nano | Hausner | Flow- |
| Compound(s) | content | activity | particles | ratio | dex |
| ferrous bisglycinate | <7% | <0.5 | <1% | 1.0-1.25 | <20 |
| ferrous asparto | <7% | <0.5 | <1% | 1.0-1.25 | <20 |
| glycinate | | | | | |
| ferric glycinate | <7% | <0.5 | <1% | 1.0-1.25 | <20 |
| calcium bisglycinate | <6% | <0.5 | <1% | 1.0-1.25 | <20 |
| calcium citrate | <6% | <0.5 | <1% | 1.0-1.25 | <20 |
| malate | | | | | |
| calcium citrate | <6% | <0.5 | <1% | 1.0-1.25 | <20 |
| zinc bisglycinate | <7% | <0.5 | <1% | 1.0-1.25 | <20 |
| zinc arginate | <7% | <0.5 | <1% | 1.0-1.25 | <20 |
| dicalcium malate | <6% | <0.5 | <1% | 1.0-1.25 | <20 |
| magnesium | <12% | <0.5 | <1% | 1.0-1.25 | <20 |
| bisglycinate | | | | | |
| magnesium lysinate | <12% | <0.5 | <1% | 1.0-1.25 | <20 |
| glycinate | | | | | |
| magnesium aspartate | <12% | <0.5 | <1% | 1.0-1.25 | <20 |
| magnesium glycyl | <12% | <0.5 | <1% | 1.0-1.25 | <20 |
| glutamine | | | | | |
| dimagnesium malate | <12% | <0.5 | <1% | 1.0-1.25 | <20 |
| magnesium citrate | <12% | <0.5 | <1% | 1.0-1.25 | <20 |
| iron citrates | <7% | <0.5 | <1% | 1.0-1.25 | <20 |
| iron malates | <7% | <0.5 | <1% | 1.0-1.25 | <20 |
| iron succinates | <7% | <0.5 | <1% | 1.0-1.25 | <20 |

(g) Other Components

In various embodiments of the present disclosure, a metal complex or metal chelate composition may contain one or more additives. Non-limiting examples of additives may include colorants, lubricants, glidants, binders, stabilizers, disintegrants, flavoring agents, capsules, solvents, coatings, preservatives, nutrients, nutraceuticals, antimicrobials, antioxidants, fillers, diluents, suspension agents, and viscosity agents.

### (II) Methods of Preparing Metal Complex or Metal Chelate Compositions

Another aspect of the present invention is a method of preparing a metal complex or metal chelate composition that comprises less than about 1% nanoparticles. Generally speaking, methods of preparing metal complex or metal chelates are known in the art. Particular parameters of the chelation reaction have been adapted to prepare a metal complex or metal chelate of the invention. Specifically, a closed reaction system is used to (a) tightly control temperature and (b) reduce oxidation during the chelation reaction. These parameters result in a shortening of production time and improvement of the reaction dynamics compared to reaction systems known in the art, which improves production efficiency and yield. Metal complex or metal chelate compositions prepared using the methods described herein do not require desiccants to maintain flowability. Because of the lack of desiccant, metal complex or metal chelate compositions prepared using the methods described herein comprise minimal nanoparticles.

Importantly, a metal complex or metal chelate composition of the present invention is prepared in a closed reactor system. That is, the reactants are not exposed to ambient air. In some embodiments, the reactor system may utilize high shear mixing. In preferred embodiments, the reaction system is pressurized, and jacketed. Such measures allow for increased reaction temperatures, when compared to open systems. Furthermore, such temperatures can be more tightly controlled. One of skill in the art understands that temperatures for specific metal complex or metal chelate reactions will vary with the metal complex or metal chelate. Preferred temperatures are disclosed in Table 3 below.

TABLE 3
Preferred Temperature Ranges for Select Chelates or Complexes

| | Temp Min | Temp Max |
|---|---|---|
| Compound(s) | (° F.) | (° F.) |
| ferrous | 130-135 | 195-200 |
| bisglycinate | | |
| ferrous | 130-135 | 195-200 |
| asparto | | |
| glycinate | | |
| ferric glycinate | 130-135 | 205-210 |
| calcium | 100-105 | 135-140 |
| bisglycinate | | |
| calcium citrate | 75-80 | 215-220 |
| malate | | |
| calcium citrate | | |
| zinc | 120-125 | 155-160 |
| bisglycinate | | |
| zinc arginate | 140-145 | 175-180 |
| dicalcium | 140-145 | 215-220 |
| malate | | |
| magnesium | 120-125 | 155-160 |
| bisglycinate | | |
| magnesium | 65-70 | 90-95 |
| lysinate | | |
| glycinate | | |
| magnesium | 90-95 | 125-130 |
| aspartate | | |
| magnesium | 80-85 | 115-120 |
| glycyl | | |
| glutamine | | |
| dimagnesium | 80-85 | 225-230 |
| malate | | |

The reactor system is pressurized, and an inert gas blanket is used within the system to reduce oxidation. Suitable inert gases may include nitrogen gas and argon gas. The reactor system is also equipped with a pressure release valve, such that gases created during the reaction may be flushed from the system and chased by the inert gas, preventing ambient air from entering the system. Such a pressure release valve aids in reducing oxidation of the metal complex or metal chelate composition.

### (III) Animal Feed Compositions

A further aspect of the present disclosure is an animal feed composition that comprises a metal complex or metal chelate composition described above.

### (IV) Method of Administering

One aspect of the present disclosure is a method of administering a metal complex or metal chelate to a subject. The method comprises administering a metal complex or metal chelate composition as described above to a subject. Suitable subjects may include humans, non-human primates, agricultural animals, laboratory animals, and companion animals.

In some embodiments, a metal complex or metal chelate composition is administered for hematologic support, energy supplementation, bone and soft tissue support, mental acuity, memory and cognition support, cardiovascular support, hepatic support, immunologic or neurologic support and prenatal, infant, toddler and childhood nutrition.

### EXAMPLES

The following examples are included to demonstrate various embodiments of the present disclosure. It should be appreciated by those of skill in the art that the techniques disclosed in the examples that follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

A chelation reaction of minerals was performed in a closed, high shear, pressurized, jacketed, cone-bottomed reactor (closed chelation reaction) and the resulting chelated minerals were spray dried in a tower-style drier (closed dryer). When compared, the reaction rate for a closed chelation reaction was significantly higher compared to the reaction rate of an open chelation reaction. Performing the closed chelation reaction reduced the reaction batch time by ˜30% compared to the reaction batch time using the open chelation reaction. The improved efficiency of the closed chelation reaction in the closed system allowed the spray drying though a closed dryer to be more efficient with less down time in the process and a more continuous flow from the dryer compared to an open system.

### Example 2

An iron chelate was prepared in a closed system as follows. The chelation reaction was performed in a closed, high shear, pressurized, jacketed, cone-bottomed reactor. During the reaction, a nitrogen blanket was applied while a pressure release valve allowed gas from the reaction to escape and was chased by the infused nitrogen which prevents oxygen from entering the closed reactor. Using a nitrogen blanket after the reaction gases were evacuated from the reaction vessel prevents oxidation of the reacted material. About 5% oxidized iron (Fe⁺⁺⁺) was detected in the end product produced by an open system whereas no oxidized iron was detected in the end product produced by the closed system. Additionally, the actualized drying rate of iron chelate formed in the closed system was increased to about 670 lbs. per hour vs 435 lbs. per hour drying rate of iron chelate formed in the open system. The reaction rate was also decreased from a rate of approximately 8 hours per 1000 gal (in a box dryer) to 6 hrs. per 1500 gal (in a tower dryer). Typical lot size increased from about 18,000 pounds (lbs) to about 28,500 lbs. The shortening of the production time and the improvement of the reaction dynamics, with a method that dramatically reduces oxidation has, besides improved production efficiency and yield, eliminated the need for a desiccant.

### Example 3

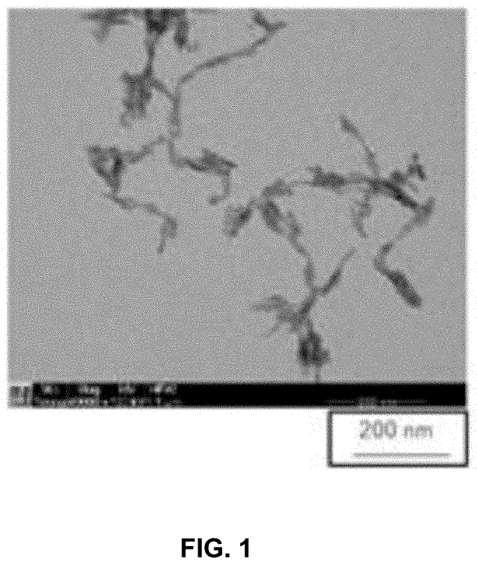

Chelated material produced using the open system requires the addition of a desiccant, such as silicon dioxide, to prevent or reduce the amount of internal moisture, or water activity, that drives the oxidative process. A key concern regarding silicon dioxide is the particle size, which contains nanoparticles in its particle size spectrum. These nanoparticles are the source of potential concern to dietary regulators. Transmission electron microscopy (TEM) confirmed that ferrous bisglycinate, a chelate that requires the addition of silicon dioxide, contains nanoparticles (FIG. 1).

What is claimed is:

1. A metal complex or metal chelate composition with a water content of less than about 15% and less than about 1% nanoparticles by total weight of the composition.

2. The metal complex or metal chelate composition of claim 1, wherein the metal complex or metal chelate comprises an amino acid ligand.

3. The metal complex or metal chelate composition of claim 1, wherein the water activity measure of the composition is less than about 0.5.

4. The metal complex or metal chelate composition of claim 1, wherein the composition has less than about 0.5% nanoparticles by total weight of the composition.

5. The metal complex or metal chelate composition of claim 4, wherein the composition has less than about 0.25% nanoparticles by total weight of the composition.

6. The metal complex or metal chelate composition of claim 4, wherein the composition has less than about 0.1% nanoparticles by total weight of the composition.

7. The metal complex or metal chelate composition of claim 1, wherein the composition has a water content of less than about 12%.

8. The metal complex or metal chelate composition of claim 7, wherein the composition has a water content of less than about 10%.

9. The metal complex or metal chelate composition of claim 7, wherein the composition has a water content of less than about 8%.

10. The metal complex or metal chelate composition of claim 7, wherein the composition has a water content of less than about 6%.

11. The metal complex or metal chelate composition of claim 1, wherein the composition is stored in moisture resistant packaging.

12. The metal complex or metal chelate composition of claim 1, wherein the water content is measured at the end of the manufacturing run or after the composition has been stored for about 3 months in moisture resistant packaging.

13. The metal complex or metal chelate composition of claim 1, wherein the composition has excellent flowability, as determined by a Hausner ratio of less than 1.25 or a Flowdex index of less than 20.

14. The metal complex or metal chelate composition of claim 1, wherein the metal is selected from the group consisting of iron, magnesium, zinc, calcium, and combinations thereof.

15. An animal feed comprising, the animal feed comprising a metal complex or metal chelate of claim 1.

16. A metal complex or metal chelate composition with excellent flowability as determined by a Hausner ratio of less than 1.12 or a Flowdex index of less than 10, wherein the composition has less than 1% nanoparticles by total weight of the composition.

17. A method for administering an organic metal complex or metal chelate to a subject, the method comprising administering a metal complex or metal chelate composition of claim 1.

18. The method of claim 17 in which the composition is administered for hematologic support, energy supplementation, mental acuity, memory and cognition support, cardiovascular, hepatic or neurologic support.
